(19) United States
(12) Patent Application Publication
(10) Pub. No.: US 2009/0236440 A1
(43) Pub. Date: Sep. 24, 2009

(54) DISPENSER COMPRISING ELECTROMAGNETIC LOCKING WITH A MAGNET AND REED SWITCH

(75) Inventors: James Anderson, Hull (GB); Wu Jin, Hull (GB); Simon Woolley, Hull (GB); Ivan Ye, GuangDong (CN)

Correspondence Address: NORRIS, MCLAUGHLIN & MARCUS, 875 THIRD AVE, 18TH FLOOR, NEW YORK, NY, 10022, US

(73) Assignee: Reckitt Benckiser (UK) Limited, Berkshire (GB)

(21) Appl. No.: 11/721,624

(22) PCT Filed: Dec. 7, 2005
(86) PCT No.: PCT/GB05/04705

§ 371 Date: Jun. 13, 2007

(30) Foreign Application Priority Data
Dec. 17, 2004 (GB) 0427646.5

(51) Int. Cl. B05B 9/03

(52) U.S. Cl. 239/67

(57) ABSTRACT

A material dispensing device (10) having a material container (12) and a dispensing section operable to control dispensing of a material from the material container (12) via the ejection section, wherein the material dispensing device (10) comprises electromagnetic locking means (28,30) comprising a first part (30) associated with the material container and a second part (28) associated with the dispensing section (14), wherein the electromagnetic locking means (28,30) is adapted to require the proximity of the first and second parts (28,30) to one another to adopt an unlocked configuration.

This invention relates to a material ejection device and to a method of controlling the output of material from a material ejection device.

Air treatment products such as air fresheners, air fragrances, pest control products, as well as other products that are ejected or sprayed from a container are typically tightly controlled by the producer of the product to have required characteristics and levels of quality. It is in the interests of a producer to allow only certain products to be used with certain spraying or material ejection apparatus.

Also, it is beneficial to a producer of a product that is to be sprayed or ejected from an apparatus to design the spraying or material ejection apparatus to work correctly with an intended type of material. Design issues in the spraying apparatus are closely dependent upon the type of materials sprayed from the container. In view of this, a designer of a spraying apparatus or material ejection apparatus would typically like to control what refills are used with the spraying apparatus so that the best function can be achieved and the best safety is achieved also.

It is an object of the present invention to address the problems set out above.

According to a first aspect of the present invention there is provided a material dispensing device having a material container and a dispensing section operable to control dispensing of a material from the material container via the dispensing section, wherein the material dispensing device comprises electromagnetic locking means comprising a first part associated with the material container and a second part associated with the dispensing section, wherein the electromagnetic locking means is adapted to require the proximity of the first and second parts to one another to adopt an unlocked configuration.

Preferably, the first part is a magnet, preferably a permanent magnet. The first part may be secured to the material container, and/or may be located within the material container, and/or may be integral with the material container. The second part may be a part of or may be secured to the dispensing section.

Preferably, the second part is a switch operable to close in the presence of an electromagnetic field, preferably a magnetic field. Preferably, the switch is a passive switch. Preferably, the second part is a reed switch. Preferably, the electromagnetic locking means is adapted to adopt the unlocked configuration when the first and second parts thereof are in the proximity of one another, but spaced apart.

The dispensing section may be an ejection section.

The electromagnetic locking means preferably comprise a passive lock element, which may be the second part.

The electromagnetic locking means may be adapted to control a power supply to a control unit of the dispensing section. The control unit may be adapted to control a valve operable to allow release of material from the material container.

The electromagnetic locking means may be adapted to provide a control signal to a control unit of the dispensing section, which control signal may be used to allow release of material from the material container.

The control unit may incorporate indication means, which may be operable to indicate, preferably visually and/or audibly, a status of the device.

According to a second aspect of the invention there is provided a material container, the material container being adapted to hold a material for dispensing from the container, the container including a first part of an electromagnetic locking means, the electromagnetic locking means being adapted to require the proximity to one another of the first part and a second, separate, part of the electromagnetic locking means to adopt an unlocked configuration.

The material container may be an aerosol container. The material container may be a disposable container, preferably for consumable materials.

According to a third aspect of the invention there is provided a dispensing section of a material dispensing device, the dispensing section being operable to control dispensing of material from a material container secured thereto, wherein the dispensing section incorporates a second part of an electromagnetic locking means, the latter being adapted to require the proximity to one another of the second part and a first, separate, part of the electromagnetic locking means to adopt an unlocked configuration thereof.

According to a fourth aspect of the invention there is provided a method of controlling an output of material from a material container, the method comprising requiring the proximity to one another of first and second parts of an electromagnetic locking means to allow an unlocked configuration, and therefore dispensing of material from the material container, to be adopted, wherein the first part is secured to or part of a material container and the second part is secured to or part of a dispensing section.

All of the features described herein may be combined with any of the above aspects in any combination.

For a better understanding of the invention, and to show how embodiments of the same may be carried into effect, reference will now be made, by way of example, to the accompanying diagrammatic drawings in which:

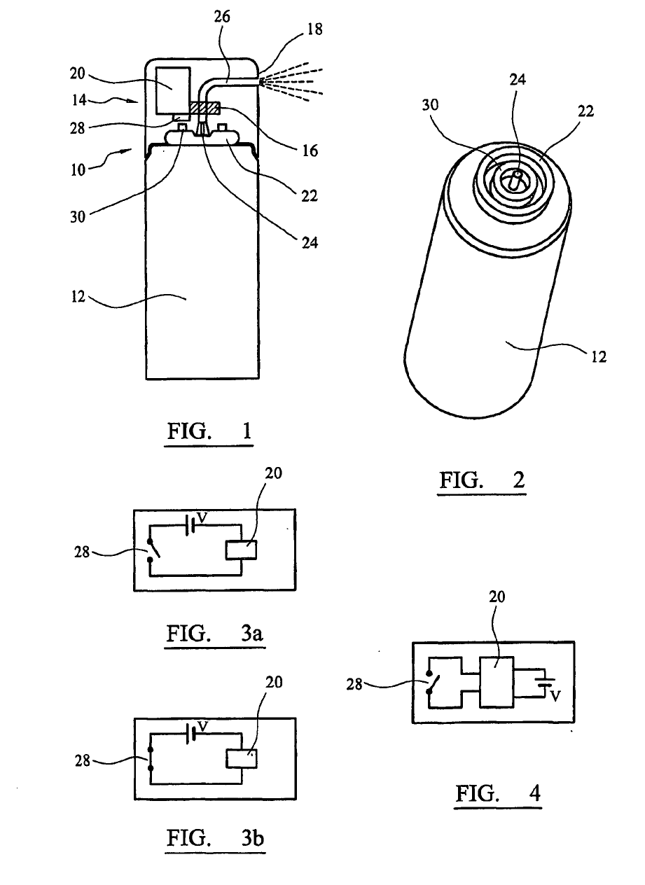

FIG. 1 is a schematic partly cross-sectional side view of a spray material container with an ejection section of a material ejection device secured thereto;

FIG. 2 is a schematic perspective view from above of the spray container shown in FIG. 1;

FIGS. 3a and 3b are schematic circuit diagrams of a control unit of the ejection section of FIG. 1 showing an open and a closed switch thereof respectively; and

FIG. 4 is a schematic circuit diagram of a different embodiment of control unit circuitry to that shown in FIGS. 3a and 3b.

A spraying device 10 comprises a spraying material container 12 and a spraying section 14 secured to the spraying material container 12, the latter in this example being an aerosol canister. The spraying section 14 comprises a valve 16 which controls a flow of spray material from the spray material container 12 to an outlet section 18. The outlet section 18 is controlled by a control unit 20.

In this example, the spray material container 12 incorporates a sealing crimp portion 22 from which exits a stem 24, as is usual in an aerosol canister. A channel 26 communicates between the stem 24 and the outlet section 18 via the valve 16.

The following addresses the problem of an unauthorised spraying material container 12 being used with the spraying section 14, which as discussed above could have safety implications or may result in malfunctioning of the spray section in view of a particular type of spray material held within the spray material container 12. The control unit 20 is arranged to function and allow operation of the valve 16 and the ejection or release by emanation of material held in the spray material container upon activation of a reed switch 28, which is electrically connected to the control unit 20 and acts as a power switch for the control unit 20. By controlling power to the control unit 20 the reed switch 28 also controls actuation of the valve 16 and the thus ejection of material from the spray material container 12.

As is well known in the art a reed switch functions in the presence of a magnetic field from a permanent magnet or an electromagnet placed in close proximity with the reed switch 28. A permanent magnet should be taken to be a material that can provide an appreciable magnetic field after initial magnetisation or excitation. A reed switch typically consists of a sealed glass tube containing two or three springy metal reeds having plated, long life contacts at the tips. The two-reed type has normally open contacts which close when operated, i.e. in the presence of a magnetic field. The three reed type is a changeover type, i.e. it has a pair of normally open and a pair of normally closed contacts. In the three reed type when the switch is operated by a magnetic field both pairs of reeds change to the opposite state. In the example described herein the reed switch 28 is of a normally open type so that in the absence of a magnetic field the reed switch will be open and will not allow the control unit 20, hence the valve 16, to function.

In order to ensure that the spray section 14 is only used with an approved spray material container 12 a magnet 30 is provided on the spray material container 12, or alternatively in the container 12, or otherwise associated with the container 12. In the example shown in FIGS. 1 and 2 the magnet 30 is in the form of a ring secured to the crimp portion of the spray material container 12. In the magnet 30 poles of the magnet are orientated vertically one above another, in this example the north pole of the magnet forms the top surface of the ring and the south pole forms the bottom surface. Alternatively, the south pole could form the upper surface and the north pole the lower surface.

The magnet 30 has a snap fit on to the crimp portion 22 or alternatively may be secured to the spray material container 12 with adhesive.

An alternative shape of magnet 30 to the ring shown in FIGS. 1 and 2 would be to have a small cylindrical magnet which could be secured with adhesive. The magnet 30 may be formed by placing magnetic powder material into a plastics formulation for production into a ring-shape to allow the magnet 30 to be more easily snap fitted on to the spray material container 12. The powder material within the plastics formulation can then be magnetised after production to form the magnet 30.

The reed switch 28 and magnet can work in conjunction with each other up to a sensing distance of approximately 15 mm. The reed switch 28 is advantageously small in size, being typically circular in cross-section with a diameter of approximately 4 mm and a length of approximately 12 mm. Where a button type or cylindrical shaped magnet is used it may have a diameter of approximately 5 mm and a height of approximately 6 mm.

In order to function correctly, the reed switch 28 should be in close proximity to the magnet 30, as shown in FIG. 1. In this example a sensing distance is typically within 15 mm, with a distance of 8 mm being preferred. A ring-shaped magnet 30 has advantages in that the relative orientation of the spray material container 12 (and its magnet 30) to the reed switch 28 in the spraying section 14 is more easily achieved, because the magnet 30 extends all the way around the top of the spray material container 12. This would not be the case with a cylindrical or button type magnet secured to the spray material container 12, which would require correct relative location of the spray container 12 and the spraying section 14.

FIGS. 3a and 3b show a simple circuit in which the control unit 20 is powered by a power source V only when the reed switch 28 is closed. Thus, in FIG. 3a the reed switch 28 is not in the presence of a magnetic field and so is open thereby ceasing a supply of power to the control unit which cannot then power the valve 16 and so the spray section 14 cannot release material from the spray material container 12. In FIG. 3b the reed switch 28 is in the presence of a magnetic field from the magnet 30 and so the reed switch 28 is closed allowing power from the power source V to be used by the control unit 20 to control the valve 16 and allow material from the spray material container 12 to be ejected.

The circuits of FIGS. 3a and 3b show a simple type of control in which the reed switch 28 is in series with the control unit 20 and the power supply V controls a supply of power to the control unit 20.

An alternative embodiment for use of the reed switch 28 is shown in the schematic circuit diagram of FIG. 4. In FIG. 4 a power source V is connected in parallel to the control unit 20, but the supply of power from the power source V is not controlled by the reed switch 28. Instead, the reed switch 28 acts as an input to the control unit 20 to provide to the control unit information as to whether an authorised spray material container 12 is attached to the spraying section 14. In this example, the control unit incorporates a timer which causes the valve 16 to activate at predetermined periods of time to eject a controlled amount of material from the spray material container 12.

The spraying device 10 may also have a boost function which provides output of material from the spray material container 12 more frequently. This function could be added to the counter unit to factor in an increased output from the spray material container 12 which will of course result in the spray material container 12 being emptied sooner than would otherwise have been the case.

The method described above by which a level of material remaining in the spray material container 12 is estimated can suitably be described as a passive method, as opposed to direct detection of how much material remains in the spray material container 12.

An additional or alternative indication, either a visual or audible indication could also be provided to a user when the spraying section 14 malfunctions, for example an indication may be given if an unauthorised spray material container 12, without a magnet 30, is attached to the spraying section 14, which would mean that the spraying device 10 would not function.

Power for the spraying device 10 may be provided by a commonly available power cell or may be by means of electricity by the provision of a spraying device 10 which can be plugged into an electrical socket.

The spray material container 12 described in relation to the embodiments above is an aerosol container. However, the spraying device 10 could equally well function with any spray material container that is electrically switched or electrically controlled. Consequently, a spray material container could be any pressurized canister or could be a container in which material which is pumped by an electrically controlled or electrically operated pump.

The spraying device 10 described above is particularly suitable for the dispersal of air treatment products, such as fragrances, sanitising materials, deodorising materials, pest control materials, cleaning materials, depilatory materials, or any other material which is sprayed from a container using a spraying section, of the type described above. The reference to ejection of material may be taken to include devices which eject material by transfer up a wick to a heat or fan-blown dispersal element.

It has been found that there are significant advantages in the provision of a powerless electrical switching system, such as that provided by the reed switch 28 and magnet 30 pair described above. For a relatively low additional cost the spray material containers 12 can be produced with a magnet 30 secured thereto in a position close to a reed switch 28. The spraying section 14 which is in this example is provided with the reed switch 28, but the reed switch 28 need not be incorporated directly into the spray section 14, can be manufactured for only a small additional cost. The benefits provided are significant in that only spray material containers 12 which have authorisation from the manufacturer or provider of a spray section 14 can be used. This results in both safety and efficiency benefits, because unauthorised materials cannot be sprayed with the spraying section 14.

Reed switches also have advantages over switches that operate by making physical contact. Thus where failure to make contact would have resulted in malfunction of a switch, the situation here is that the magnet need only be in the vicinity of the reed switch, rather than in direct physical contact.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A material dispensing device having a material container and a dispensing section operable to control dispensing of a material from the material container via the dispensing section, wherein the material dispensing device comprises electromagnetic locking means comprising a first part associated with the material container and a second part associated with the dispensing section, wherein the electromagnetic locking means is adapted to require the proximity of the first and second parts to one another to adopt an unlocked configuration.

2. A material dispensing device as claimed in claim 1, in which the first part is a magnet.

3. A material dispensing device as claimed in claim 1 or claim 2, in which the second part is a switch operable to close in the presence of an electromagnetic field.

4. A material dispensing device as claimed in any preceding claim, in which the second part is a reed switch.

5. A material dispensing device as claimed in any preceding claim, in which the electromagnetic locking means comprise a passive lock element, which is the second part.

6. A material dispensing device as claimed in any preceding claim, in which the electromagnetic locking means are adapted to control a power supply to a control unit of the dispensing section.

7. A material dispensing device as claimed in claim 6, in which the control unit is adapted to control a valve operable to allow release of material from the material container.

8. A material dispensing device as claimed in any one of claims 1 to 5, in which the electromagnetic locking means are adapted to provide a control signal to a control unit of the dispensing section, which control signal may be used to allow release of material from the material container.

9. A material dispensing device as claimed in any one of claims 6 to 8, in which the control unit incorporates indication means, which are operable to indicate, visually and/or audibly, a status of the device.

10. A material container adapted to hold a material for dispensing from the container, the container including a first part of an electromagnetic locking means, the electromagnetic locking means being adapted to require the proximity to one another of the first part and a second, separate, part of the electromagnetic locking means to adopt an unlocked configuration.

11. A material container as claimed in claim 10, in which the material container is an aerosol container.

12. A dispensing section of a material dispensing device, the dispensing section being operable to control dispensing of material from a material container secured thereto, wherein the dispensing section incorporates a second part of an electromagnetic locking means, the latter being adapted to require the proximity to one another of the second part and a first, separate, part of the electromagnetic locking means to adopt an unlocked configuration thereof.

13. A method of controlling an output of material from a material container, the method comprising requiring the proximity to one another of first and second parts of an electromagnetic locking means to allow an unlocked configuration, and therefore dispensing of material from the material container, to be adopted, wherein the first part is secured to or part of a material container and the second part is secured to or part of a dispensing section.

14. A material dispensing device substantially as described herein with reference to the accompanying drawings.

15. A material container substantially as described herein with reference to the accompanying drawings.

16. A dispensing section of a material device substantially as described herein with reference to the accompanying drawings.

17. A method of controlling an output of material from a material container substantially as described herein with reference to the accompanying drawings.
